(19) United States
(12) Patent Application Publication
(10) Pub. No.: US 2022/0143630 A1
(43) Pub. Date: May 12, 2022

(54) SHOWER HEAD WITH SPRAY GUN FUNCTION

(71) Applicant: Xiamen Prime Shower Co.,Ltd, Xiamen (CN)

(72) Inventors: Haibo HONG, Xiamen (CN); Qin YU, Xiamen (CN); Jing GUO, Xiamen (CN)

(21) Appl. No.: 17/582,163

(22) Filed: Jan. 24, 2022

(30) Foreign Application Priority Data
Jan. 20, 2022 (CN) 202220149735.0

(51) Int. Cl. B05B 1/16; B05B 1/18; B05B 9/01; B05B 12/00

(52) U.S. Cl. CPC B05B 1/16; B05B 12/002; B05B 9/01; B05B 1/18

(57) ABSTRACT

The present disclosure discloses a shower head with a spray gun function and relates to the technical field of bathroom products. The shower head includes a shower head shell, the shower head shell, a surface cover water-outflowing body and a water distribution mechanism, and a hollow installing inner cavity is formed by the surface cover water-outflowing body and the shower head shell. By adopting the above technical solution, the present disclosure has functions of spray gun water outflowing and shower head water outflowing, water outflowing is switched by pressing a button, and thus the shower head is convenient to use and more suitable for meeting using demands of a consumer.

### CROSS-REFERENCE TO RELATED APPLICATIONS

This application claims the benefit of priority from Chinese Patent Application No. 202220149735.0, filed on Jan. 20, 2022. The content of the aforementioned application, including any intervening amendments thereto, is incorporated herein by reference in its entirety.

### FIELD

The present disclosure relates to the technical field of bathroom products, in particular to a shower head with a spray gun function.

### BACKGROUND

A shower head, also called a lotus-seedpod-shaped head, is originally an apparatus for watering flowers, potted plants and other plants and is transformed into a shower fixture afterwards to be a common facility in a bathroom. A spray gun is a device using rapid releasing of liquid or compressed air as power. In the prior art, in general, the shower head and the spray gun are simply assembled to realize functions of the spray gun and the shower head, or the spray gun is configured independently for use, occupying space is large during installation, use is inconvenient, and user experience is unfavorable.

In view of this, the present disclosure is developed and designed through deep conception and active study, improvement and trial specific to various defects and inconveniences caused by the above imperfection.

### SUMMARY

The present disclosure aims to provide a shower head with a spray gun function which has functions of spray gun and shower head water-outflowing, performs water-outflowing switching by pressing buttons and is convenient to use and more suitable for meeting using demands of a consumer.

In order to realize the above objectives, the present disclosure adopts the following technical solution.

A shower head with a spray gun function includes:

a shower head shell, having a water flow channel;

a surface cover water-outflowing body, arranged on the shower head shell, wherein a hollow installing inner cavity is formed by the surface cover water-outflowing body and the shower head shell; and

a water distribution mechanism, arranged in the installing inner cavity, wherein the water distribution mechanism has a water entering pipe, a spray gun water flow channel and a shower head water flow channel, the water entering pipe communicates with the water flow channel, the spray gun water flow channel and the shower head water flow channel, a spray gun water outlet is formed in the spray gun water flow channel, and a shower head water outlet is formed in the shower head water flow channel and communicates with the surface cover water-outflowing body; a switching assembly is arranged on the water distribution mechanism and includes a valve shaft, a valve sleeve and a button, the valve shaft is movably arranged in the valve sleeve, the valve sleeve is arranged on the water distribution mechanism, the button is arranged on the valve shaft, and the valve shaft is controlled to move up and down by pressing the button so that the switching assembly can communicate with the spray gun water flow channel or the shower head water flow channel.

Furthermore, a first seal ring is arranged between the valve shaft and the valve sleeve.

Furthermore, a spray gun water-outflowing nozzle is further included, communicates with the spray gun water outlet and is embedded into the shower head shell.

Furthermore, the switching assembly further includes a spring, and the spring is elastically connected with the valve shaft.

Furthermore, a sealing assembly is further included and includes a seal cover, a second seal ring, a seal cover welded body and a water distribution mechanism welded part, wherein the water distribution mechanism welded part is welded to a side surface of the water distribution mechanism, the spray gun water flow channel and the shower head water flow channel are sealed, the seal cover is arranged at a bottom of the water distribution mechanism, the second seal ring is arranged between the seal cover and the water distribution mechanism, the seal cover welded body is welded to a bottom of the seal cover, and the seal cover and the seal cover welded body communicate with the shower head water outlet and the surface cover water-outflowing body.

Furthermore, a massage water rotor is further included, arranged at a bottom of the seal cover welded body and connected with the water distribution mechanism, and the surface cover water-outflowing body is arranged on an outer side of the massage water rotor in a sleeving mode.

Furthermore, a plurality of surface cover water outlets for water outflowing of the shower head are formed in the surface cover water-outflowing body.

Furthermore, a decorative cover is further included, is arranged on an outer side of the surface cover water-outflowing body, is rotatable relative to the surface cover water-outflowing body and is provided with openings corresponding to the surface cover water outlets and further provided with a handle, and the decorative cover is rotated through the handle so as to switch relative positions of the decorative cover and the surface cover water-outflowing body.

Furthermore, the shower head shell is further provided with a water inlet, the water inlet is connected with the water flow channel, a threaded stopper is installed at the water inlet, and the shower head shell is installed on a water source water-outflowing pipe through the threaded stopper.

By adopting the above technical solution, in the present disclosure, the water distribution mechanism is arranged, so the functions of shower head water outflowing and spray gun water outflowing are realized, and switching of two types of water outflowing is performed by pressing the button. The present disclosure is simple in structure, small in occupying space, convenient to use and more suitable for meeting the demands of the consumer, and the user experience feeling is better.

### BRIEF DESCRIPTION OF THE DRAWINGS

In order to set forth an example of the present disclosure or the technical solution in the prior art more clearly, accompanying drawings needed in the description of the example or the prior art will be simply introduced below. Apparently, the drawings in the following description are only some examples of the present disclosure, and those ordinarily skilled in the art can obtain other drawings according to these drawings without creative work.

FIG. 1 is an exploded view of the present disclosure.

FIG. 2 is a schematic structural diagram of a water distribution mechanism in the present disclosure.

FIG. 3 is a schematic structural diagram of the present disclosure.

FIG. 4 is a sectional view of the present disclosure in a natural state.

FIG. 5 is an enlarged view of a portion A in FIG. 4.

FIG. 6 is a sectional view of spray gun water outflowing by pressing one end of a button in the present disclosure.

FIG. 7 is an enlarged view of a portion B in FIG. 6.

FIG. 8 is a sectional view of shower head water outflowing by pressing the other end of a button in the present disclosure.

FIG. 9 is an enlarged view of a portion C in FIG. 8.

### DETAILED DESCRIPTION OF EMBODIMENTS

In order to further explain the technical solution of the present disclosure, the present disclosure is set forth in detail below with reference to the specific examples.

In the description of the present disclosure, it needs to be understood that terms “center”, “longitudinal”, “transverse”, “upper”, “lower”, “front”, “back”, “left”, “right”, “vertical”, “horizontal”, “top”, “bottom”, “inner”, “outer” and the like which indicate orientations or position relations are based on orientations or position relations shown in the drawings, only intend to conveniently describe the present disclosure and simplify the description rather than indicate or imply that a reference apparatus or element must have a specific orientation or be configured and operated in the specific orientation, thereby being not constructed as limiting the present disclosure. In the description of the present disclosure, “a plurality of” means “two” or “more than two” unless otherwise stated.

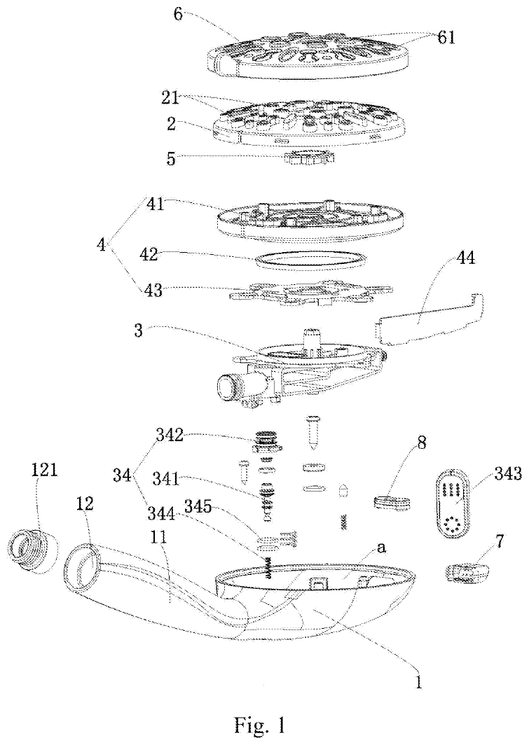

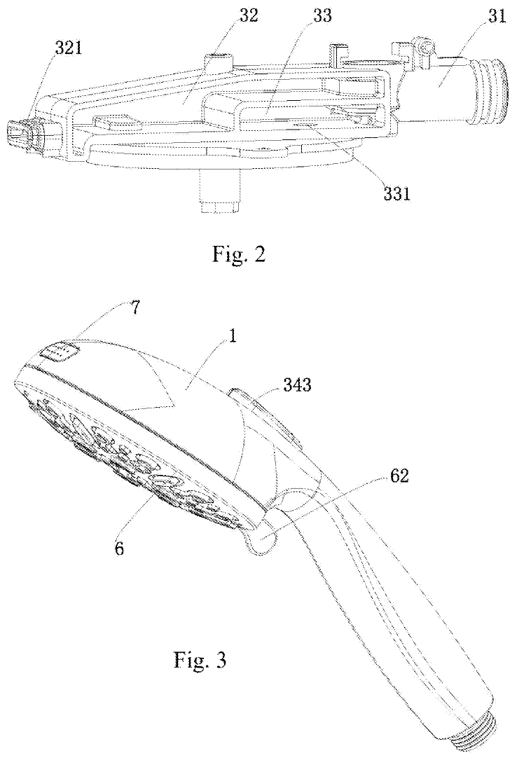

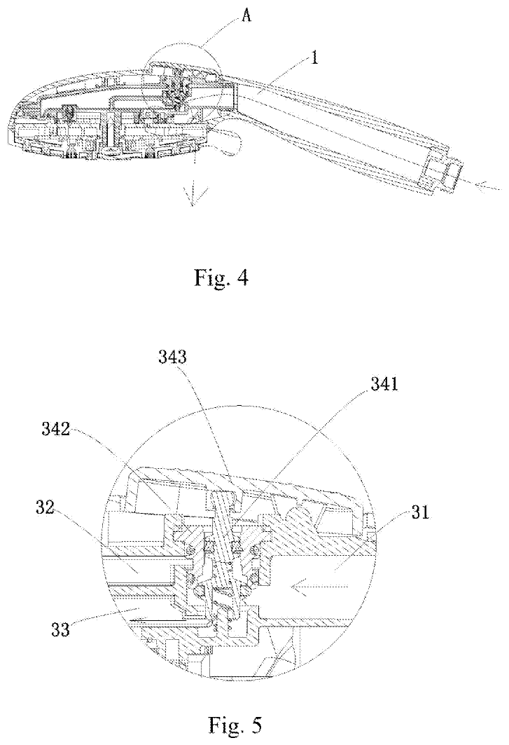

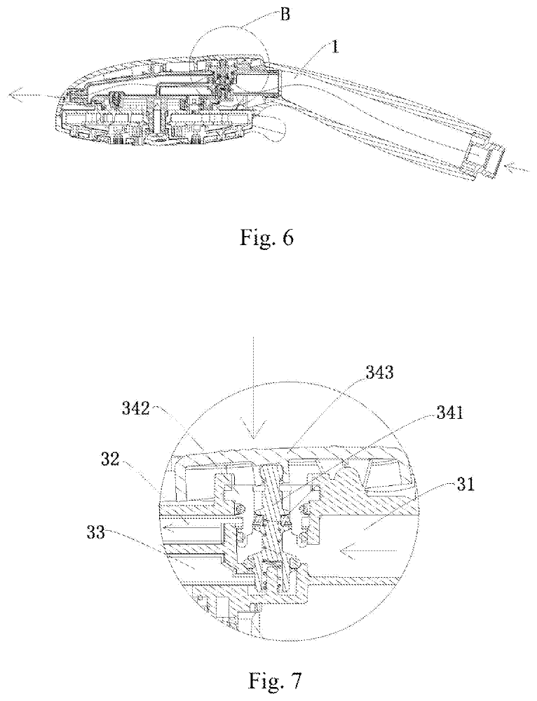

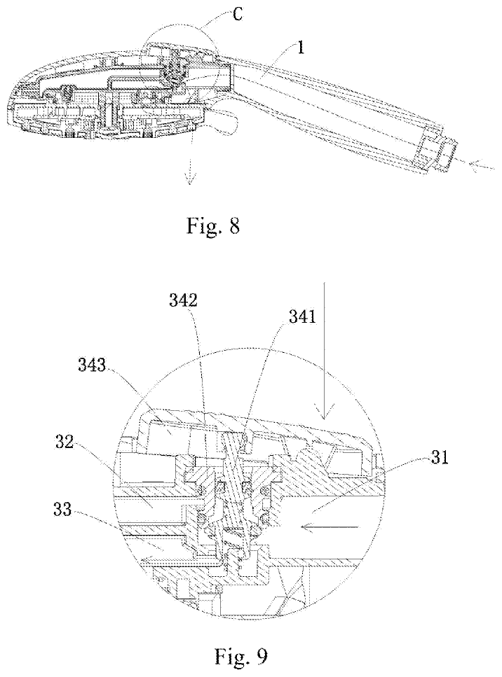

Referring to FIG. 1 to FIG. 9, the present disclosure discloses a shower head with a spray gun function, including a shower head shell 1, a surface cover water-outflowing body 2, a water distribution mechanism 3, a sealing assembly 4, a massage water rotor 5, a decorative cover 6 and a spray gun water-outflowing nozzle 7.

The shower head shell 1 has a water flow channel 11 and a water inlet 12. The water inlet 12 is connected with the water flow channel 11, a threaded stopper 121 is installed at the water inlet 12, and the shower head shell 1 is installed on a water source water-outflowing pipe through the threaded stopper 121.

The surface cover water-outflowing body 2 is arranged on the shower head shell 1, a hollow installing inner cavity a is formed by the surface cover water-outflowing body 2 and the shower head shell 1, and a plurality of surface cover water outlets 21 for water outflowing of the shower head are formed in the surface cover water-outflowing body 2.

The water distribution mechanism 3 is arranged in the installing inner cavity a and has a water entering pipe 31, a spray gun water flow channel 32, a shower head water flow channel 33 and a switching assembly 34. The water entering pipe 31 communicates with the water flow channel 11, the spray gun water flow channel 32 and the shower head water flow channel 33, a shower head water outlet 331 is formed in the shower head water flow channel 33, a spray gun water outlet 321 is formed in the spray gun water flow channel 32, the water entering pipe 31 communicates with the spray gun water flow channel 32 and the shower head water flow channel 33, and the shower head water outlet 331 communicates with the surface cover water-outflowing body 2.

The spray gun water-outflowing nozzle 7 communicates with the spray gun water outlet 321 and is embedded into the shower head shell 1. A water flow flows through the spray gun water flow channel 32, then flows to the spray gun water-outflowing nozzle 7 through the spray gun water outlet 321 and then flows out through the spray gun water-outflowing nozzle 7.

The shower head water outlet 331 communicates with the surface cover water-outflowing body 2. A water flow flows through the shower head water flow channel 33, then flows to the surface cover water-outflowing body 2 through the shower head water outlet 331 and then flows out through the surface cover water outlets 21 in the surface cover water-outflowing body 2.

The switching assembly 34 includes a valve shaft 341, a valve sleeve 342, a button 343 and a spring 344. The valve shaft 341 is movably arranged in the valve sleeve 342, the valve sleeve 342 is arranged on the water distribution mechanism 3, the button 343 is arranged on the valve shaft 341, and the spring 344 is elastically connected with the valve shaft 341. The valve shaft 341 is controlled to move up and down by pressing the button 343 so that the switching assembly 344 can communicate with the spray gun water flow channel 32 or the shower head water flow channel 33. A first seal ring 345 is arranged between the valve shaft 341 and the valve sleeve 342 and can play a role in sealing between the valve shaft 341 and the valve sleeve 342.

The sealing assembly 4 includes a seal cover 41, a second seal ring 42, a seal cover welded body 43 and a water distribution mechanism welded part 44. The water distribution mechanism welded part 44 is welded to a side surface of the water distribution mechanism 3, and the spray gun water flow channel 32 and the shower water flow channel 33 are sealed. The seal cover 41 is arranged at a bottom of the water distribution mechanism 3. The second seal ring 42 is arranged between the seal cover 41 and the water distribution mechanism 3 and performs sealing between the seal cover 41 and the water distribution mechanism 3. The seal cover welded body 43 is welded to a bottom of the seal cover 41. The seal cover 41 and the seal cover welded body 43 communicate with the shower head water outlet 331 and the surface cover water-outflowing body 2. The water flow flows out through the shower head water outlet 331, then flows to the surface cover water-outflowing body 2 through a connection relation that the seal cover 41 and the seal cover welded body 43 communicate with the shower head water outlet 331 and the surface cover water-outflowing body 2 and then flows out through the surface cover water-outflowing body 2. The sealing assembly 4 is arranged to play a role in sealing between the water distribution mechanism 3 in the shower head shell 1 and the surface cover water-outflowing body 2 so as to prevent water leakage.

A cat eye washer 8 is further arranged, is disposed in a position where the shower head water outlet 331 of the water distribution mechanism 3 communicates with the seal cover 41 and can play a role in sealing so as to prevent water leakage.

The massage water rotor 5 is arranged at a bottom of the seal cover welded body 43 and connected with the water distribution mechanism 3, and the surface cover water-outflowing body 2 is arranged on an outer side of the massage water rotor 5 in a sleeving mode.

The decorative cover 6 is arranged on an outer side of the surface cover water-outflowing body 2, is rotatable relative to the surface cover water-outflowing body 2 and is provided with openings 61 corresponding to the surface cover water outlets 21 and further provided with a handle 62. The decorative cover 6 is rotated through the handle 62 so as to switch relative positions between the openings 61 in the decorative cover 6 and the surface cover water outlets 21 in the surface cover water-outflowing body 2, and a water outflowing range of the shower head is controlled by changing a position relation between the openings 61 and the surface cover water outlets 21.

A working principle of the present disclosure is: the shower head shell 1 is installed on the water source water-outflowing pipe through the threaded stopper 121, and the water flow flows out through the water source water-outflowing pipe, flows to the water flow channel 11 through the water inlet 12, then flows to the water entering pipe 31 of the water distribution mechanism 3 through the water flow channel 11 and then flows into the water entering pipe 31;

when no water enters the shower head, that is, the button 343 is in a natural state, the valve shaft 341 is controlled to move upward under an action of an elastic force of the spring 344, a water entering position, corresponding to the spray gun water flow channel 32, of the valve sleeve 342 is sealed, and at the moment, the shower head water flow channel 33 and the water entering pipe 31 are in a communicating state (as shown in FIG. 5); when water enters the shower head, the water flow enters the shower head water flow channel 33 through the water entering pipe 31, then flows to the shower head water outlet 331 through the shower head water flow channel 33, flows to the surface cover water-outflowing body 2 through the shower head water outlet 331 and flows out through the surface cover water outlets 21 in the surface cover water-outflowing body 2, at the moment, different water outflowing ranges can be switched by switching the handle 62 of the decorative cover 6, in the state, it can be guaranteed that water flows out of the shower head the minute the water enters the shower head, and thus it is more suitable for meeting the using demands of the consumer;

when spray gun water outflowing is needed, one end of the button 343 is pressed, the valve shaft 341 moves downwards under pressing of the button 343, the water flow may have a backpressure at the valve shaft 341, at the moment, the backpressure is higher than the elastic force of the spring 344, the valve shaft 341 seals a water entering position of the shower head water flow channel 33, and at the moment, the spray gun water flow channel 32 and the water entering pipe 31 are in a communicating state (as shown in FIG. 7), when water enters the shower head, the water flow enters the spray gun water flow channel 32 through the water entering pipe 31, then flows to the spray gun water outlet 321 through the spray gun water flow channel 32, flows to the spray gun water-outflowing nozzle 7 through the spray gun water outlet 321 and then flows out through the spray gun water-outflowing nozzle 7, and outflowing water of the spray gun water-outflowing nozzle 7 is large in volume, high in impact force and capable of being used for washing a floor, cleaning out contaminants and dirt, etc.; and

when using of spray gun water outflowing is completed and it needs to switch to shower head water outflowing, the other end of the button 343 is pressed, at the moment, the button 343 is lifted up, the valve shaft 341 is driven to move upwards, at the moment, the valve shaft 341 seals the water entering position, corresponding to the spray gun water flow channel 32, of the valve sleeve 342, the water flow flows to the shower head water outlet 331, and at the moment, water flows out of the shower head.

The shower head and the spray gun are designed in an integrated mode, water distribution is performed through the water distribution mechanism 3, water outflowing is switched by arranging the button, the shower head is convenient to use, simple in structure, small in occupying space and more suitable for meeting the using demands of the consumer, and the user experience feeling is better.

The above description only intends to set forth the technical solution of the present disclosure rather than form a limit. All other changes or equivalent replacements made by those ordinarily skilled in the art for the technical solution of the present disclosure fall within the scope of the claims of the present disclosure without departing from the spirit and scope of the technical solution of the present disclosure.

What is claimed is:

1. A shower head with a spray gun function, comprising:
a shower head shell, having a water flow channel;
a surface cover water-outflowing body, arranged on the shower head shell, wherein a hollow installing inner cavity is formed by the surface cover water-outflowing body and the shower head shell; and
a water distribution mechanism, arranged in the installing inner cavity, wherein the water distribution mechanism has a water entering pipe, a spray gun water flow channel and a shower head water flow channel, the water entering pipe communicates with the water flow channel, the spray gun water flow channel and the shower head water flow channel, a spray gun water outlet is formed in the spray gun water flow channel, and a shower head water outlet is formed in the shower head water flow channel and communicates with the surface cover water-outflowing body; a switching assembly is arranged on the water distribution mechanism and comprises a valve shaft, a valve sleeve and a button, the valve shaft is movably arranged in the valve sleeve, the valve sleeve is arranged on the water distribution mechanism, the button is arranged on the valve shaft, and the valve shaft is controlled to move up and down by pressing the button so that the switching assembly can communicate with the spray gun water flow channel or the shower head water flow channel.

2. The shower head with the spray gun function according to claim 1, wherein: a first seal ring is arranged between the valve shaft and the valve sleeve.

3. The shower head with the spray gun function according to claim 1, further comprising a spray gun water-outflowing nozzle, wherein the spray gun water-outflowing nozzle communicates with the spray gun water outlet and is embedded into the shower head shell.

4. The shower head with the spray gun function according to claim 1, wherein the switching assembly further comprises a spring, and the spring is elastically connected with the valve shaft.

5. The shower head with the spray gun function according to claim 1, further comprising a sealing assembly, wherein the sealing assembly comprises a seal cover, a second seal ring, a seal cover welded body and a water distribution mechanism welded part, the water distribution mechanism welded part is welded to a side surface of the water distribution mechanism, the spray gun water flow channel and the shower head water flow channel are sealed, the seal cover is arranged at a bottom of the water distribution mechanism, the second seal ring is arranged between the seal cover and the water distribution mechanism, the seal cover welded body is welded to a bottom of the seal cover, and the seal cover and the seal cover welded body communicate with the shower head water outlet and the surface cover water-outflowing body.

6. The shower head with the spray gun function according to claim 5, further comprising a massage water rotor, wherein the massage water rotor is arranged at a bottom of the seal cover welded body and connected with the water distribution mechanism, and the surface cover water-outflowing body is arranged on an outer side of the massage water rotor in a sleeving mode.

7. The shower head with the spray gun function according to claim 1, wherein a plurality of surface cover water outlets for water outflowing of the shower head are formed in the surface cover water-outflowing body.

8. The shower head with the spray gun function according to claim 7, further comprising a decorative cover, wherein the decorative cover is arranged on an outer side of the surface cover water-outflowing body, is rotatable relative to the surface cover water-outflowing body and is provided with openings corresponding to the surface cover water outlets and further provided with a handle, and the decorative cover is rotated through the handle so as to switch relative positions of the decorative cover and the surface cover water-outflowing body.

9. The shower head with the spray gun function according to claim 1, wherein the shower head shell is further provided with a water inlet, the water inlet is connected with the water flow channel, a threaded stopper is installed at the water inlet, and the shower head shell is installed on a water source water-outflowing pipe through the threaded stopper.
